(19) United States
(12) Patent Application Publication
(10) Pub. No.: US 2015/0309635 A1
(43) Pub. Date: Oct. 29, 2015

(54) METHOD FOR USING A CONTROLLER ON A TOUCH SENSITIVE DEVICE

(71) Applicant: TIANJIN FUNAYUANCHUANG TECHNOLOGY CO., LTD., Tianjin (CN)

(72) Inventors: PO-SHENG SHIH, New Taipei (TW); CHIEN-YUNG CHENG, New Taipei (TW); PIN-LUNG LIN, New Taipei (TW); MING-CHUN CHIU, New Taipei (TW)

(21) Appl. No.: 14/678,201

(22) Filed: Apr. 3, 2015

(30) Foreign Application Priority Data
Apr. 24, 2014 (CN) 201410167401.6

(51) Int. Cl. G06F 3/041

(52) U.S. Cl. CPC G06F 3/0412

(57) ABSTRACT

The disclosure relates to a method for using a controller on a touch sensitive device. The touch sensitive device includes a touch pad and an integrated circuit (IC) electrically connected to the touch pad. The method includes: providing at least one controller; identifying the at least one controller; detecting position of electrical signal of the at least one controller; locating the at least one controller; detecting varying of the electrical signal of the at least one controller; processing the varying of electrical signal; and sending out an order.

### CROSS-REFERENCE TO RELTATED APPLICATIONS

This application claims priority to Chinese Patent Application No. 201410167401.6 filed on Apr. 24, 2014 in the China Intellectual Property Office, the contents of which are incorporated by reference herein.

### FIELD

The subject matter herein generally relates to a method for using a controller on a touch sensitive device.

### BACKGROUND

A notebook is popular for their convenience. Notebooks typically include a touch pad for controlling the mouse pointer. However, the touch pad of notebook is usually controlled by an object, such as fingers. Therefore, the function of the touch pad is limited by the controlling methods.

What is needed, therefore, is to provide a method for using a controller on a touch sensitive device which can overcome the shortcomings as described above.

### BRIEF DESCRIPTION OF THE DRAWINGS

Implementations of the present technology will now be described, by way of example only, with reference to the attached figures, wherein:

FIG. 1 is a schematic view of one embodiment of a notebook.

FIG. 2 is a schematic view of one embodiment of a touch pad and a joystick.

FIG. 3 is a photo picture of one embodiment of a notebook and a joystick.

FIG. 4 is a schematic view of one embodiment of a capacitance shape and a capacitance value of a joystick.

FIG. 5 is a schematic view of one embodiment of a capacitance shape and a capacitance value of a finger.

FIG. 6 is a schematic view of one embodiment of a capacitance shape and a capacitance value of a palm.

FIG. 7 is a schematic view of one embodiment of a touch pad with a function area.

FIG. 8 is a flow chart of one embodiment of a method for connecting a touch pad to a controller.

FIG. 9 is a flow chart of the other embodiment of a method for connecting a touch pad to a controller.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

The present disclosure relates to a method for using a controller on a touch sensitive device of a computer. The computer can be a notebook, game machine, or a learning machine.

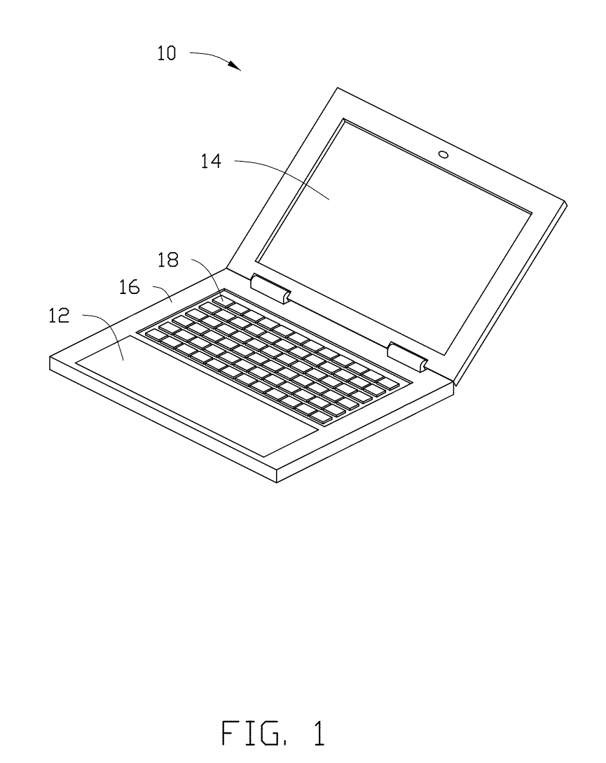

FIG. 1 illustrates a notebook 10 of one embodiment. The notebook 10 includes a main processor case 16, a display screen 14 connected to the main processor case 16, a touch pad 12 and a keyboard 18 located on a surface of the main processor case 16.

The touch pad 12 is a large touch pad. The large touch pad includes that the size of the touch pad 12 along a length direction is the same as a length of the keyboard 18. When the finger tip of the user touch the touch pad 12, it is easy for the wrist or palm of the user to touch the touch pad 12 to cause a misoperation. The size and shape of the touch pad 12 can be selected according to need. The touch pad 12 can be rectangular with a length in a range from about 25 centimeters to about 40 centimeters, and a width in a range from about 6 centimeters to about 12 centimeters. In one embodiment, the touch pad 12 is rectangular with a length about 32 centimeters and a width about 8 centimeters. A length direction of the touch pad 12 is defined as X direction, and a width direction of the touch pad 12 is defined as Y direction. The touch pad 12 extends from a first edge of the main processor case 16 to a second edge of the main processor case 16 opposite to the first edge. In some embodiments, the touch pad 12 and keyboard 18 share the same width. The touch pad 12 can be located on bottom, right side, or left side of the keyboard 18.

The touch pad 12 can be any type such as capacitance-type, resistance-type, electromagnetic type or hybrid type. The hybrid type can be a mixture of the capacitance-type, the resistance-type and the electromagnetic type, or a mixture of the capacitance-type, the resistance-type and the electromagnetic type with other types of touch pad 12, such as outside type or surface acoustic wave type.

The touch pad 12 is electrically connected to an integrated circuit (IC). The integrated circuit is electrically connected to the main processor case 16. The touch pad 12 and the integrated circuit form the touch sensitive device of the disclosure.

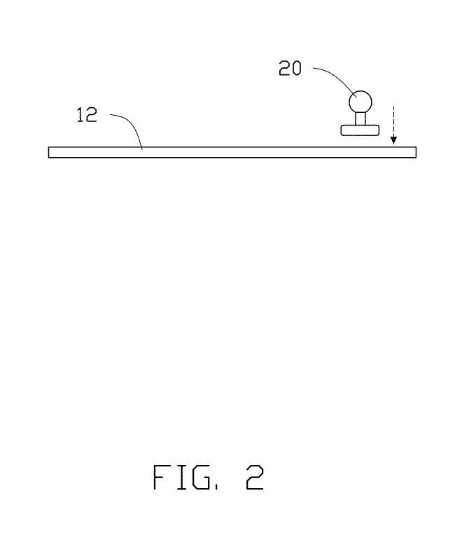

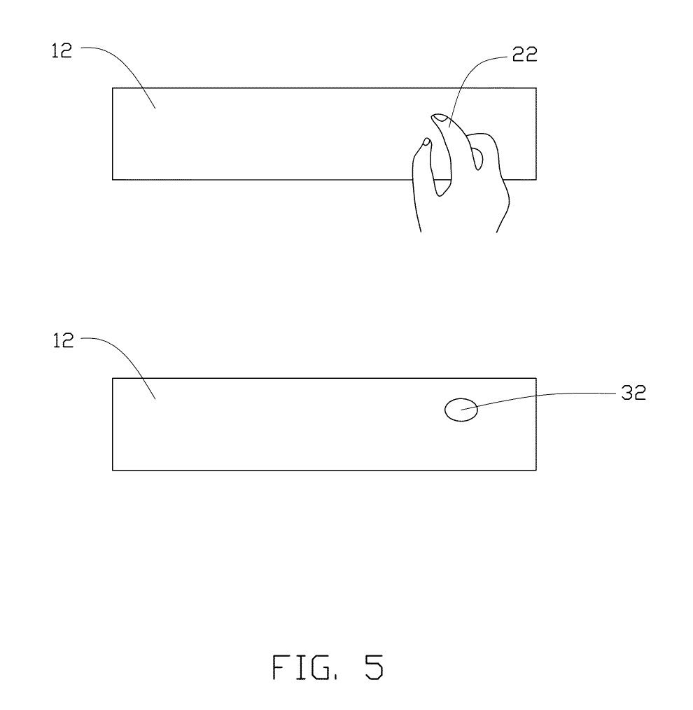

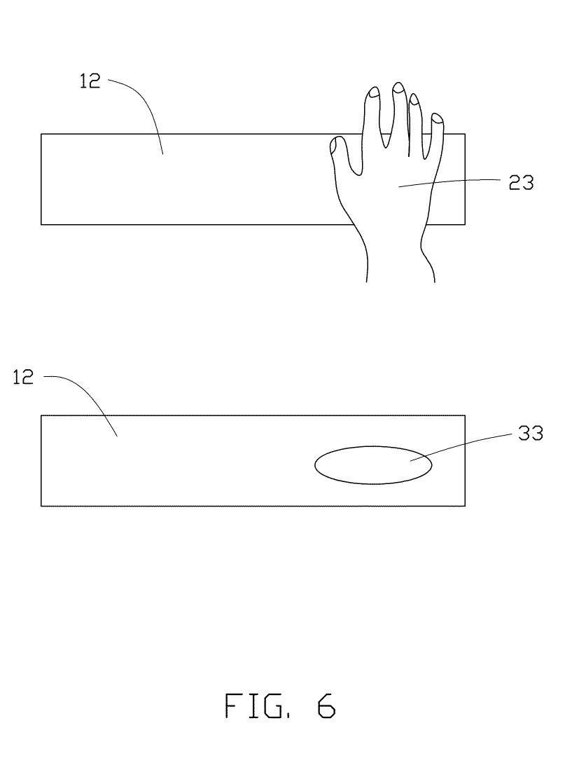

Referring to FIGS. 2 to 9, a method for using a controller 20 on a touch sensitive device of one embodiment includes following steps:

step (S11), providing a controller 20, and identifying the controller 20;

step (S12), detecting position of electrical signal of the controller 20, and locating the controller 20; and

step (S13), detecting varying of electrical signal of the controller 20, processing the varying of electrical signal and sending out an order.

In step (S11), the identifying the controller 20 includes identifying type and number of the controller 20. The type of the controller 20 can be joystick, button, keyboard or magnetic cover. The keyboard can be a digital keyboard, keyboard of the piano or other keyboard. The controller 20 includes electrical conductive material.

The identifying the controller 20 includes identifying the controller 20 by the integrated circuit itself directly, or the integrated circuit directly ask the main processor case 16 to identify the controller 20.

In one embodiment, step (S11) includes electrically connecting the controller 20 to the integrated circuit, and identifying the type of the controller 20 by reading the identification (ID) information of the controller 20 by the integrated circuit. The controller 20 can be connected to the integrated circuit by wireless method such as bluetooth, infrared, Wifi or RFID; or by wire method such as USB and FPC. The type of the controller 20 can be identified accurately by reading the ID information.

In one embodiment, step (S11) includes placing the controller 20 on a surface of the touch pad 12, detecting the electrical signal shape or electrical signal value of the controller 20 by the integrated circuit, and comparing the electrical signal shape or electrical signal value with a base shape or base value. The controller 20 is designed with an electrical signal shape or electrical signal value different with an electrical signal shape or electrical signal value of a finger or palm. Different electrical signal shape or electrical signal value of the controller 20 is stored in the integrated circuit as the base shape or base value. The electrical signal can be capacitance, resistance, electromagnetic, current or voltage.

When the controller 20 is placed on the surface of the touch pad 12 and identified by detecting and comparing the electrical signal shape or electrical signal value, the identifying the controller 20 of step (S11) and the locating the controller 20 of step (S12) can be performed simultaneously.

If a plurality of controllers 20 are provided, the identifying the controller 20 includes identifying the plurality of controllers 20 respectively.

In step (S12), after the controller 20 is placed on the surface of the touch pad 12, the locating the controller 20 is performed according to the detected position of the electrical signal of the controller 20. The electrical signal can be capacitance, resistance, electromagnetic, current or voltage.

When the touch pad 12 is capacitance-type, the controller 20 should be kept being in contact with the people user during detecting position of the electrical signal of the controller 20. For example, the user holds the joystick. Because human body static electricity, a capacitance would be generated between the touch pad 12 and the controller 20. The capacitance between the touch pad 12 and the controller 20 is defined as the capacitance of the controller 20. The locating the controller 20 is to get a location of the controller 20 on the touch pad 12.

Furthermore, after locating the controller 20, a step of: dividing the touch pad 12 into a function area 122 and a rest area 124. In the function area 122, the integrated circuit only send out order according to varying of electrical signal of the controller 20, would not send out any order according to varying of electrical signal of an object such as finger or palm. When the object touches the rest area 124, the integrated circuit will send out order according to varying of electrical signal of the object so as to achieve the function of mouse and gesture recognition. The rest area 124 has the original function, and the function area 122 realizes the function of the controller 20.

In one embodiment, the integrated circuit can also send out order according to the varying of electrical signal of the controller 20 and the gesture of the object through the function area 122, such as the object moves from the function area 122 to the rest area 124, or form the rest area 124 to the function area 122.

The function area 122 can be an area around the position of the controller 20. In one embodiment, all the position of electrical signal of the controller 20 is in the function area 122. The function area 122 is movable according to the movement of the controller 20. If more than one controllers 20 are provided, more than one function areas 122 should be defined. Each function area 122 corresponds to one of the more than one controllers 20.

In one embodiment, step (S12) includes: dividing the touch pad 12 into a plurality of areas; placing the controller 20 on a surface of the touch pad 12; detecting position of electrical signal of the controller 20; and correcting and locating the controller 20 according to the position of electrical signal of the controller 20. If the position of electrical signal of the controller 20 is in the object area, no need to correct. If the position of electrical signal of the controller 20 is out of the object area, need to correct by dividing the touch pad 12 again according to the position of electrical signal of the controller 20.

In step (S13), the integrated circuit process the varying of electrical signal and send out an order to the main processor case 16.

The varying of electrical signal of the controller 20 depends on the type of the controller 20. When the touch pad 12 is capacitance-type, the controller 20 is joystick, the varying of electrical signal is a continuous capacitance varying. When the controller 20 is a button or keyboard, the varying of electrical signal is appearance or disappearance of one or more than one capacitance with the shape of the button.

Different examples of the methods are provided below.

### Example 1

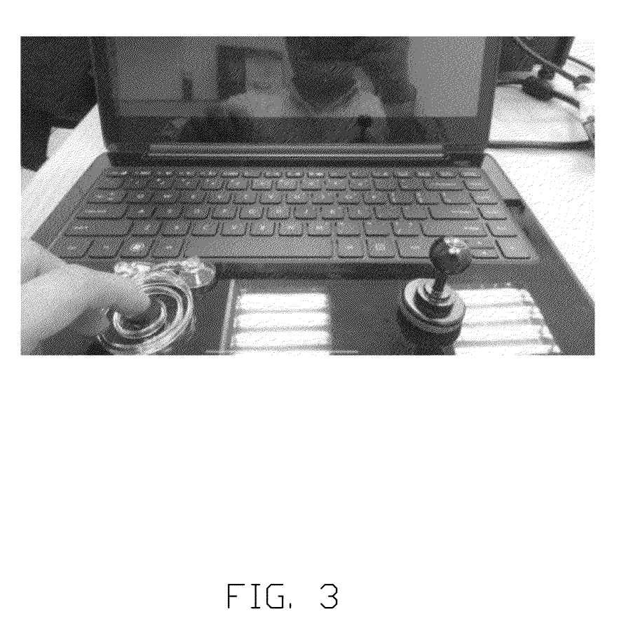

Referring to FIGS. 2-3, a method for using a controller 20 on a touch sensitive device of example 1 includes following steps:

step (S21), placing a controller 20 on a surface of the touch pad 12, and identifying and locating the controller 20 by detecting a capacitance shape and/or capacitance value of the controller 20; and

step (S22), detecting varying of capacitance of the controller 20, and sending out an order to the main processor case 16 according to the varying of capacitance.

The method of example 1 is suitable for controller 20 with a substantially regular capacitance shape, such as round capacitance, square capacitance, rectangle capacitance, or triangle capacitance. The capacitance shape of the joystick can be designed as round capacitance. The capacitance shape of the keyboard can be designed as rectangle capacitance.

In step (S21), when a joystick is placed on the surface of the touch pad 12, the touch pad 12 detects a round capacitance. When a keyboard is placed on the surface of the touch pad 12, the touch pad 12 detects a rectangle capacitance.

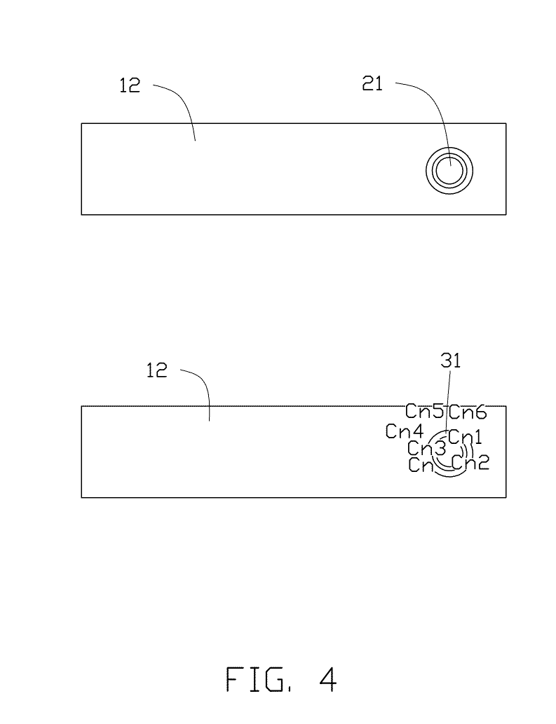

As shown in FIGS. 4-6, the capacitance shape and capacitance value of the joystick 21, finger 22, and palm 23 are obvious different. The integrated circuit compares the detected capacitance shape with the base shape and identifies the type of the controller 20.

In step (S22), when the joystick 21 is shook ahead, back, on right or on left, because the projection shape and projection area of the joystick 21 on the touch pad 12 are continuously changed, the detected capacitance shape and capacitance value of the joystick 21 are also continuously changed. The integrated circuit process the capacitance varying, and sending out an order, such as go ahead, go back, turn right or turn left, to the main processor case 16. As shown in FIG. 3, the joystick 21 can be used together with other buttons.

### Example 2

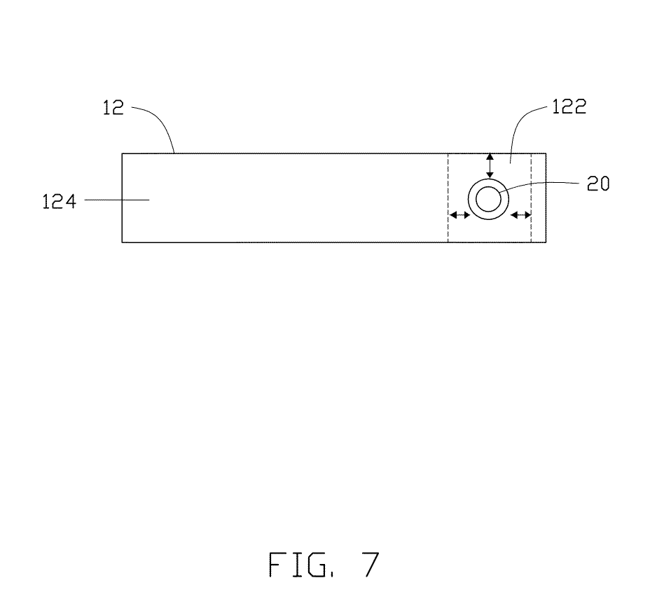

Referring to FIG. 7, a method for using a controller 20 on a touch sensitive device of example 2 includes following steps:

step (S31), placing a controller 20 on a surface of the touch pad 12, and identifying and locating the controller 20 by detecting a capacitance shape and/or capacitance value of the controller 20;

step (S32), defining a function area 122 and a rest area 124 on the touch pad 12 according to the position of the controller 20; and

step (S33), detecting varying of capacitance of the controller 20, and sending out an order to the main processor case 16 according to the varying of capacitance.

The method of example 2 is similar with the method of example 1 above, except that a step of defining a function area 122 and a rest area 124 on the touch pad 12 according to the position of the controller 20 is performed.

The function area 122 is a square having the center point overlapped with the center point of the bottom surface of the joystick 21. The function area 122 is larger than the capacitance area of the joystick 21. The function area 122 is movable according to the movement of the joystick 21. The function area 122 can avoids misoperation of palm of user.

### Example 3

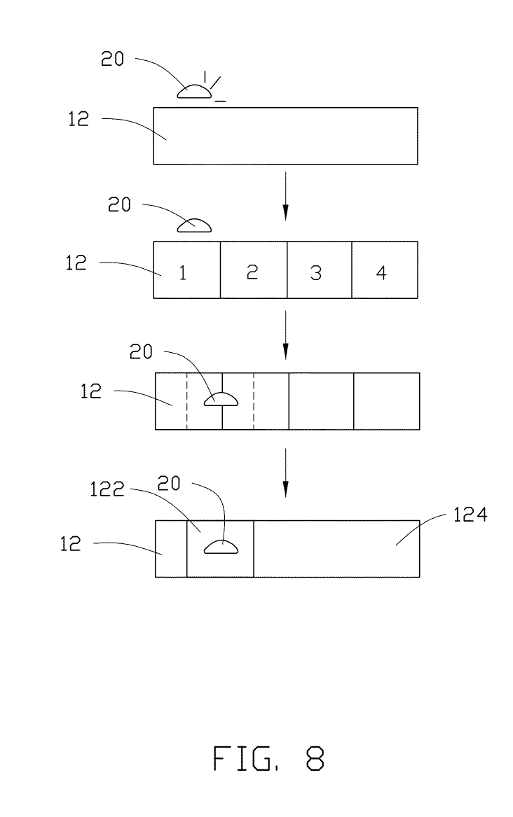

Referring to FIG. 8, a method for using a controller 20 on a touch sensitive device of example 3 includes following steps:

step (S41), matching a controller 20 with the touch sensitive device by bluetooth, and identifying the controller 20 by reading the ID information of the controller 20;

step (S42), dividing the touch pad 12 into a plurality of areas, and placing the controller 20 on a surface of the touch pad 12;

step (S43), judging whether the controller 20 is in one of the plurality of areas, if yes, defining the one of the plurality of areas as a function area 122 and go to step (S45), if no, go to step (S44);

step (S44), dividing the touch pad 12 again, and defining a function area 122 and a rest area 124 according to the position of electrical signal of the controller 20; and

step (S45), detecting varying of capacitance of the controller 20, and sending out an order to the main processor case 16 according to the varying of capacitance.

In step (S42), the touch pad 12 can be divided according to the function area 122 of the controller 20. In one embodiment, the touch pad 12 is divided into four same areas, and each of the four areas is the same as the function area 122.

### Example 4

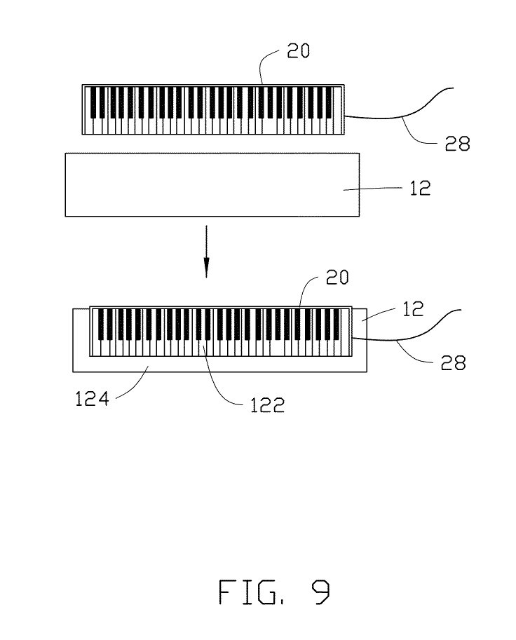

Referring to FIG. 9, a method for using a controller 20 on a touch sensitive device of example 4 includes following steps:

step (S51), connecting a controller 20 with the touch sensitive device by a wire 28, and identifying the controller 20 by reading the ID information of the controller 20;

step (S52), placing the controller 20 on a surface of the touch pad 12, and locating the controller 20;

step (S53), dividing the touch pad 12 into a function area 122 and a rest area 124 according to the position of the controller 20; and

step (S54), detecting varying of capacitance of the controller 20, and sending out an order to the main processor case 16 according to the varying of capacitance.

The method of example 4 is similar with the method of example 3 above, except that the controller 20 is connected with the touch sensitive device by the wire 28, and the touch pad 12 is directly divided into the function area 122 corresponding to the controller 20 and the rest area 124. In one embodiment, the controller 20 is a keyboard of the piano, and the keyboard of the piano is connected to the USB of the notebook 10 so as to connect with the touch sensitive device. The function areas 122 corresponds to the keyboard of the piano.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A method for using a controller on a touch sensitive device, the method comprises the following steps:
providing a controller and a touch sensitive device comprising a touch pad and an integrated circuit;
identifying the controller;
detecting a position of an electrical signal of the controller;
locating the controller;
detecting varying of the electrical signal of the controller; and
processing the varying of the electrical signal and sending out an order.

2. The method of claim 1, wherein the touch pad is selected from the group consisting of a capacitance-type touch pad, a resistance-type touch pad, an electromagnetic type touch pad and a hybrid type touch pad.

3. The method of claim 1, wherein the identifying the controller comprises identifying a type of controller or number of the controller.

4. The method of claim 3, wherein the type of controller is selected from the group consisting of a joystick, button, keyboard and magnetic cover.

5. The method of claim 1, wherein the providing the controller comprises electrically connecting the controller to the integrated circuit.

6. The method of claim 5, wherein the controller is electrically connected to the integrated circuit by a wireless method selected from the group consisting of bluetooth, infrared, Wifi and RFID.

7. The method of claim 5, wherein the controller is electrically connected to the integrated circuit by a wired method selected from the group consisting of USB and FPC.

8. The method of claim 5, wherein the identifying the controller comprises identifying the type of controller by reading an identification information of the controller.

9. The method of claim 1, wherein the providing the controller comprises the controller being on a surface of the touch pad.

10. The method of claim 9, wherein the identifying the controller comprises detecting a shape or a value of the electrical signal; and comparing the shape or the value of the electrical signal with a base shape or base value.

11. The method of claim 1, wherein the electrical signal is selected from the group consisting of capacitance, resistance, electromagnetic, current and voltage.

12. The method of claim 1, further comprising dividing the touch pad into a function area and a rest area; wherein in the function area, the integrated circuit only send out order according to the varying of the electrical signal.

13. The method of claim 12, wherein the function area surround all positions of the electrical signal.

14. The method of claim 12, wherein the function area surround the controller.

15. The method of claim 1, further comprising dividing the touch pad into a function area and a rest area; wherein in the function area, the integrated circuit only send out order according to the varying of the electrical signal and a gesture of an object through the function area.

16. The method of claim 15, wherein the gesture of the object is selected from the group consisting of moving from the function area to the rest area and moving form the rest area to the function area.

17. A method for using a controller on a touch sensitive device, the method comprises the following steps:
providing a controller and a touch sensitive device comprising a touch pad and an integrated circuit;
placing the controller on a surface of the touch pad;
identifying the controller by detecting a shape or value of an electrical signal of the controller;
locating the controller by detecting a position of the electrical signal of the controller;
detecting varying of the electrical signal; and
sending out an order according to the varying of the electrical signal.

18. The method of claim 17, wherein the locating the controller comprises dividing the touch pad in to a plurality of areas; judging whether the controller is in one of the plurality of areas, if yes, defining the one of the plurality of areas as a first function area, and if no, dividing the touch pad again into a second function area around the position of electrical signal and a rest area.

19. A method for using a controller on a touch sensitive device, the method comprises the following steps:
providing a controller, a main processor case and a touch sensitive device comprising a touch pad and an integrated circuit;
electrically connecting the touch sensitive device to the main processor case;
identifying the controller by the main processor case and noticing the integrated circuit;
locating the controller by detecting a position of an electrical signal of the controller;
detecting varying of the electrical signal; and
sending out an order to the main processor case according to the varying of the electrical signal.

20. The method of claim 1, wherein the providing the controller comprises electrically connecting the controller to the main processor case.
